(19) United States
(12) Patent Application Publication
(10) Pub. No.: US 2024/0211991 A1
(43) Pub. Date: Jun. 27, 2024

(54) DATA PROCESSING METHOD, APPARATUS, AND COMPUTER-READABLE STORAGE MEDIUM

(71) Applicant: Tencent Technology (Shenzhen) Company Limited, Shenzhen (CN)

(72) Inventors: Chunxu SHEN, Shenzhen (CN); Hao CHENG, Shenzhen (CN)

(73) Assignee: Tencent Technology (Shenzhen) Company Limited, Shenzhen (CN)

(21) Appl. No.: 18/587,671

(22) Filed: Feb. 26, 2024

Related U.S. Application Data
(63) Continuation of application No. PCT/CN2023/088857, filed on Apr. 18, 2023.

(30) Foreign Application Priority Data
Jun. 13, 2022 (CN) 202210662836.2

(51) Int. Cl. G06Q 30/0242; G06Q 30/0251

(52) U.S. Cl. CPC G06Q 30/0242; G06Q 30/0269

(57) ABSTRACT

In a data processing method, target second-order information is determined based on current user feature information of at least one current user and first information feature information of recommended information previously recommended to the at least one current user. A nonlinear mapping of the target second-order information is determined. New user feature information of a new user is determined based on the nonlinear mapping of the target second-order information. To-be-recommended feature information corresponding to recommended information of the previously recommended information to be recommended to the new user is determined. A recommendation for the new user is generated based on the new user feature information and the to-be-recommended feature information.

### RELATED APPLICATIONS

The present application is a continuation of International Application No. PCT/CN2023/088857, filed on Apr. 18, 2023, which claims priority to Chinese Patent Application No. 202210662836.2 filed on Jun. 13, 2022. The entire disclosures of the prior applications are hereby incorporated by reference.

### FIELD OF THE TECHNOLOGY

This disclosure relates to information recommendation technologies in the field of artificial intelligence, including data processing.

### BACKGROUND OF THE DISCLOSURE

A cold start object is an object with zero conversion times during information recommendation. Since a quantity of recommended information converted by the cold start object is zero, in a conversion bipartite graph corresponding to the recommendation object and the recommended information, vertices corresponding to the cold start object are isolated vertices. Since isolated vertices in a graph neural network have no edge connection, information cannot be effectively propagated. As a result, a conversion rate (CVR) cannot be determined in a cold start scenario, which affects accuracy of information recommendation and increases resource consumption of information recommendation.

### SUMMARY

Embodiments of this disclosure include a data processing method, apparatus, and a non-transitory computer-readable storage medium, which can improve accuracy of information recommendation and reduce resource consumption of information recommendation.

Examples of technical solutions in the embodiments of this disclosure may be implemented as follows:

An embodiment of this disclosure provides a data processing method. The method is performed by a data processing device, for example. In a data processing method, target second-order information is determined based on current user feature information of at least one current user and first information feature information of recommended information previously recommended to the at least one current user. A nonlinear mapping of the target second-order information is determined. New user feature information of a new user is determined based on the nonlinear mapping of the target second-order information. To-be-recommended feature information corresponding to recommended information of the previously recommended information to be recommended to the new user is determined. A recommendation for the new user is generated based on the new user feature information and the to-be-recommended feature information.

An embodiment of this disclosure provides a data processing apparatus, including processing circuitry. The processing circuitry is configured to determine target second-order information based on current user feature information of at least one current user and first feature information of recommended information previously recommended to the at least one current user. The processing circuitry is configured to determine a nonlinear mapping of the target second-order information. The processing circuitry is configured to determine new user feature information of a new user based on the nonlinear mapping of the target second-order information. The processing circuitry is configured to determine to-be-recommended feature information corresponding to recommended information of the previously recommended information to be recommended to the new use. The processing circuitry is configured to generate a recommendation for the new user based on the new user feature information and the to-be-recommended feature information.

An embodiment of this disclosure provides a non-transitory computer-readable storage medium storing instructions which when executed by a processor cause the processor to perform any of the methods of this disclosure.

Embodiments of this disclosure may include at least the following beneficial effects: During the obtaining of the recommendation object feature, the target second-order information that is used includes not only the interaction between the objects, but also the interaction between the objects and the recommended information, which is heterogeneous information. Therefore, by performing nonlinear mapping on the target second-order information to obtain the recommendation object feature corresponding to the recommendation object, an accurate association is established between the recommendation object and the recommended information. In this way, based on the recommendation object feature, it can be accurately determined whether to recommend any recommended information to the recommendation object, thereby improving accuracy of a conversion rate (CVR), and reducing the resource consumption of information recommendation. In addition, even if the recommendation object is a cold start object, the accuracy of information recommendation can still be improved, and the resource consumption of information recommendation can still be reduced.

### BRIEF DESCRIPTION OF THE DRAWINGS

FIG. 1 is a schematic architectural diagram of an information recommendation system according to an embodiment.

FIG. 2 is a schematic structural diagram of composition of a server in FIG. 1 according to an embodiment.

FIG. 3a is a first schematic flowchart of a data processing method according to an embodiment.

FIG. 3b is a second schematic flowchart of a data processing method according to an embodiment.

FIG. 3c is a schematic flowchart of obtaining a recommendation object feature according to an embodiment.

FIG. 4a is a first schematic flowchart of model training according to an embodiment.

FIG. 4b is a second schematic flowchart of model training according to an embodiment.

FIG. 5 is a schematic diagram of an exemplary information recommendation process according to an embodiment.

FIG. 6 is a schematic diagram of an exemplary click-through bipartite graph according to an embodiment.

FIG. 7 is a schematic diagram of an exemplary social graph according to an embodiment.

FIG. 8 is a schematic diagram of an exemplary heterogeneous graph according to an embodiment.

FIG. 9 is a schematic diagram of exemplary heterogeneous information aggregation according to an embodiment.

FIG. 10 is schematic diagram of another exemplary heterogeneous information aggregation according to an embodiment.

FIG. 11 is a schematic diagram of exemplary weight updating aggregation according to an embodiment.

FIG. 12 is a schematic diagram of exemplary model performance comparison according to an embodiment.

### DESCRIPTION OF EMBODIMENTS

The objectives, technical solutions, and advantages in embodiments of this disclosure are described in further detail with reference to drawings. The described embodiments are some of the embodiments of this disclosure rather than all of the embodiments. Other embodiments are within the scope of this disclosure.

In the following description, the involved term “some embodiments” describes subsets of all possible embodiments, but it may be understood that “some embodiments” may be the same subset or different subsets of all the possible embodiments, and can be combined with each other without conflict.

In the following description, the involved terms “first\second” and the like are merely intended to distinguish between similar objects rather than describe specific orders. It may be understood that, “first\second” and the like may be transposed in a specific order or a sequence if allowed, so that the embodiments of this disclosure described herein can be implemented in an order other than those illustrated or described herein.

Unless otherwise defined, meanings of all technical and scientific terms used in the embodiments of this disclosure are the same as those usually understood by a person skilled in the art to which this disclosure belongs. The terms used in the embodiments of this disclosure are merely intended to describe objectives of the embodiments of this disclosure, and are not intended to limit this disclosure.

Before the embodiments of this disclosure are further described in detail, a description is made on nouns and terms in the embodiments of this disclosure, and the nouns and terms in the embodiments of this disclosure are applicable to the following explanations.
1) Artificial Intelligence (AI): It is a theory, a method, a technology, and an application system that use a digital computer or a machine controlled by the digital computer to simulate, extend, and expand human intelligence, so as to sense an environment, obtain knowledge, and obtain an optimal result with knowledge.
2) Machine learning (ML): It is an interdisciplinary field, involving a plurality of disciplines such as the theory of probability, statistics, the approximation theory, convex analysis, and the theory of algorithm complexity. The ML specializes in how a computer simulates or realizes learning behaviors of humans to obtain new knowledge or skills, and reorganizes existing knowledge structures to keep improving performance thereof. The ML is the core of the AI and a fundamental way to make computers intelligent, which is applied in all fields of the AI. The ML generally includes technologies such as an artificial neural network, a confidence network, reinforcement learning, transfer learning, and inductive learning.
3) Artificial neural network: It is a mathematical model that mimics structures and functions of a biological neural network. An exemplary structure of the artificial neural network in the embodiments of this disclosure includes a graph convolutional network (GCN), a deep neural network (DNN), a convolutional neural network (CNN) and a recurrent neural network (RNN), a neural state machine (NSM) and a phase-functioned neural network (PFNN), and the like. A specified heterogeneous graph and a to-be-updated heterogeneous graph involved in the embodiments of this disclosure are models corresponding to the artificial neural network.
4) Cloud computing: It is a computing mode in which computing tasks are distributed across a resource pool composed of a large quantity of computers to enable various application systems to obtain computing capabilities, storage spaces, and information services as required. A network that provides resources to the resource pool is referred to as “cloud”. The resources in the “cloud” can be infinitely expanded in the eyes of users, and can be obtained at any time, used on demand, expanded at any time, and paid for use. A data processing method provided in the embodiments of this disclosure may be implemented through the cloud computing.
5) Conversion rate (CVR): It is a probability of successful conversion. Successful conversion includes click-through, browse, download, purchase, run, register, and the like. Therefore, the CVR includes a click-through rate (CTR), a browse rate, a download rate, a purchase rate, a run rate, a register rate, and the like, such as a rate at which an account exposed to advertisements clicks an advertisement and a rate at which the account exposed to advertisements purchases a target resource.
6) Homogeneous graph: It is a graph that includes one type of node and one type of edge. An object interaction graph in the embodiments of this disclosure is a homogeneous graph.
7) Heterogeneous graph: It is a graph in which at least one of a vertex type and an edge type is greater than or equal to two types. An object information conversion graph, a specified heterogeneous graph, and a to-be-updated heterogeneous graph in the embodiments of this disclosure are all heterogeneous graphs.
8) Bipartite graph: It is a graph having two types of vertices and having edges existing between vertices of different types. In other words, a vertex set of a bipartite graph includes two subsets not intersecting each other, and the vertices at both ends of each edge in the bipartite graph belong to different subsets and therefore the vertices in the same subset are not adjacent. In the embodiments of this disclosure, the object information conversion graph is a bipartite graph, including an object set and an information set, with edges indicating that an object successfully converts information.
9) Social networking service (SNS): It is a network structure obtained by connecting objects through interaction between the objects. The interaction is a social behavior between the objects, such as becoming a fan of others, teaming up, and exchanging virtual resources.

To perform information recommendation, a corresponding recommendation policy may be determined first through a historical conversion relationship between recommended information and an object, and then information recommendation is performed based on the recommendation policy in a current information recommendation process. However, an information recommendation object varies in a different information recommendation period. In other words, a current recommendation object may not appear in the historical conversion relationship between recommended information and an object, which is a cold start object. Therefore, the recommendation policy determined based on the historical conversion relationship between recommended information and an object cannot be applied to the current recommendation object, which leads to low accuracy of information recommendation in a cold start scenario, resulting in high resource consumption of information recommendation.

In addition, to perform information recommendation, a GCN, such as a neural graph collaborative filtering (NGCF) and a light GCN may be used. The NGCF constructs a bipartite graph by using objects and information as vertices, and estimates a CVR through message propagation. The light GCN estimates the CVR by removing feature conversion and nonlinear operations in the NGCF. In an information recommendation scenario including a cold start object, since the recommendation object converts zero recommended information, in a bipartite graph corresponding to the recommendation object and the recommended information, the recommendation object is an isolated vertex. Since the isolated vertex has no edge connection in the GCN, information cannot be effectively propagated. As a result, a CVR of the recommendation object to the recommended information cannot be determined in the cold start scenario, which affects accuracy of information recommendation in the cold start scenario and increases resource consumption of information recommendation.

In addition, to perform information recommendation for the cold start object, exploration and exploitation policies may be further used. To perform information recommendation to the cold start object, transfer learning and meta learning may be further used. For example, a conversion behavior of the cold start object for recommended information in other information recommendation scenarios is learned, and knowledge transfer is employed to apply the conversion behavior to information recommendation in a current information recommendation scenario. To perform information recommendation for the cold start object, associated recommendation may be performed by using a knowledge graph (KG) based on similarity of recommended information in terms of the KG. In other words, the recommended information for the cold start object is recommended information converted by a similar object of the cold start object in terms of the KG. To perform information recommendation for a cold start object, a heterogeneous graph neural model may also be adopted, which uses an “object-recommended information” conversion bipartite graph and an “object-object” social graph as subgraphs of a full graph. The full graph (for example, a linear splicing result of the two subgraphs) is used in combination with SNS prior knowledge to perform the information recommendation for the cold start object. However, during information recommendation for cold start objects by using the exploration and exploitation policies, since the cold start objects have the same preference for different types of recommended information, a potential common preference of the cold start objects needs to be found out by trial and error. In addition, more advertisements (with a quantity greater than a quantity threshold) related to known interests of accounts (such as advertisements with CVRs greater than a threshold) need to be pushed, to promote click-through of the accounts on the advertisement materials, thereby achieving information recommendation for the cold start object. During information recommendation by fusing a knowledge graph and an “object-recommended information” conversion bipartite graph or during information recommendation by fusing a social graph and an “object-recommended information” conversion bipartite graph, since information on different graph structures is heterogeneous information, a similarity between accounts cannot be adequately measured through a linear operation, which affects accuracy of information recommendation in the cold start scenario and increases resource consumption of information recommendation.

Based on the above, the embodiments of this disclosure provide a data processing method, apparatus, and a computer-readable storage medium, which can improve accuracy of information recommendation and reduce resource consumption of information recommendation. An exemplary application of the data processing device provided in the embodiments of this disclosure is described below. The data processing device provided in the embodiments of this disclosure may be implemented as various types of terminals such as a smartphone, a smartwatch, a laptop, a tablet computer, a desktop computer, an intelligent home appliance, a set-top box, an intelligent onboard device, a portable music player, a personal digital assistant, a dedicated message device, an intelligent voice interaction device, a portable gaming device, and an intelligent speaker, or may be implemented as a server, or may be implemented as a combination of the terminal and the server. An exemplary application in which the device is implemented as a server is described below.

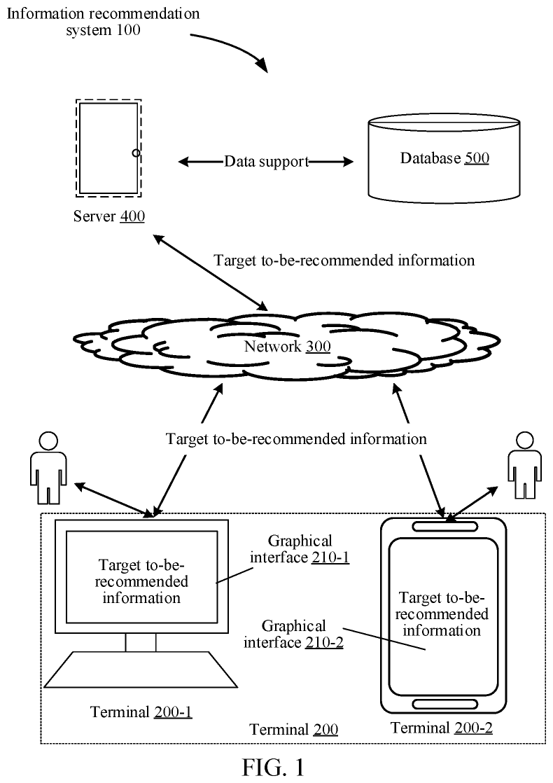

FIG. 1 is a schematic architectural diagram of an information recommendation system according to an embodiment of this disclosure. As shown in FIG. 1, to support an information recommendation application, in an information recommendation system 100, a terminal 200 (a terminal 200-1 and a terminal 200-2 are exemplified) connects to a server 400 (which is referred to as a data processing device) through a network 300. The network 300 may be a wide area network, a local area network, or a combination of the wide area network and the local area network. In addition, the information recommendation system 100 further includes a database 500 configured to provide data support for the server 400. FIG. 1 shows a case in which the database 500 is independent of the server 400. The database 500 may alternatively be integrated into the server 400, which is not limited in this embodiment of this disclosure.

The terminal 200 is configured to display target to-be-recommended information on a graphical interface (a graphical interface 210-1 and a graphical interface 210-2 are exemplified).

The server 400 is configured to: obtain a recommendation object feature corresponding to a recommendation object, the recommendation object feature being obtained through a nonlinear mapping result of target second-order information, the target second-order information being obtained by aggregating an object feature corresponding to at least one interactive object and a first information feature corresponding to at least one piece of recommended information, the interactive object being an object configured to interact with the recommendation object, and the at least one piece of recommended information being full information converted by each interactive object; obtain a to-be-recommended information feature corresponding to to-be-recommended information, the to-be-recommended information being any recommended information converted by the interactive object; and transmit, to the terminal 200 through the network 300, target to-be-recommended information recommended to the recommendation object based on a result of fusing the recommendation object feature and the to-be-recommended information feature.

In some embodiments, the server 400 may be an independent physical server, a server cluster composed of a plurality of physical servers, a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be directly or indirectly connected through wired or wireless communication, which is not limited in this embodiment of this disclosure.

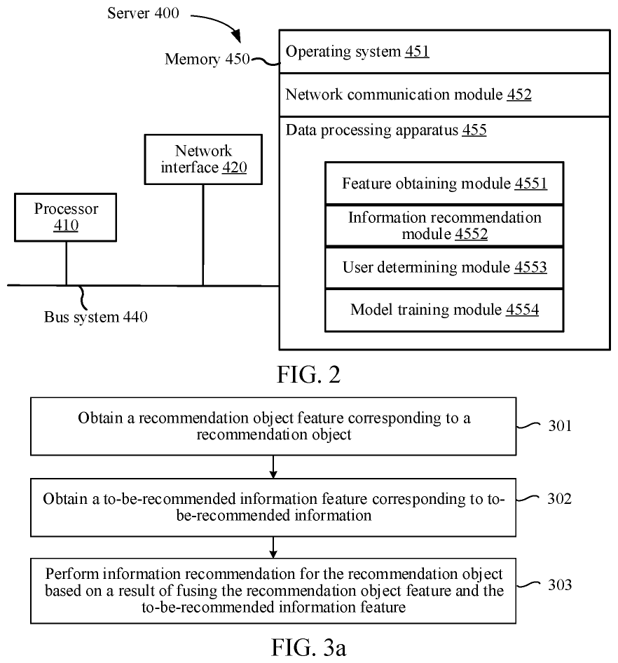

FIG. 2 is a schematic structural diagram of composition of the server in FIG. 1 according to an embodiment of this disclosure. The server 400 shown in FIG. 2 includes at least one processor 410, a memory 450, and at least one network interface 420. The components in the server 400 are coupled together through a bus system 440. It may be understood that, the bus system 440 is configured to implement connection and communication between the components. In addition to the data bus, the bus system 440 further includes a power bus, a control bus, and a status signal bus. For clarity, all of the buses are marked as the bus system 440 in FIG. 2.

The processor 410 may be an integrated circuit chip with a signal processing capability, for example, a general processor, a digital signal processor (DSP), another programmable logic device, a discrete gate or a transistor logic device, a discrete hardware component, or the like. The general processor may be a microprocessor, any conventional processor, or the like.

The memory 450 is removable, non-removable, or a combination thereof. An exemplary hardware device includes a solid-state memory, a hard disk driver, an optical disk driver, and the like. In some embodiments, the memory 450 includes one or more storage devices physically away from the processor 410.

The memory 450 may be a volatile memory or a non-volatile memory, or may include both a volatile memory and a non-volatile memory. The non-volatile memory may be a read-only memory (ROM). The volatile memory may be a random access memory (RAM). The memory 450 described in this embodiment of this disclosure is intended to include any suitable type of memory.

In some embodiments, the memory 450 can store data to support various operations. Examples of the data include a program, a module, and a data structure or a subset or a superset thereof. An exemplary description is provided below.

An operating system 451 includes system programs configured to process basic system services and perform hardware-related tasks, for example, a frame layer, a core library layer, and a drive layer, and is configured to implement basic services and process hardware-based tasks.

A network communication module 452 is configured to arrive at another computer device through one or more (wired or wireless) network interfaces 420. An exemplary network interface 420 includes Bluetooth, wireless fidelity (Wi-Fi), a universal serial bus (USB), and the like.

In some embodiments, a data processing apparatus provided in the embodiments of this disclosure may be implemented through software. FIG. 2 shows a data processing apparatus 455 stored in the memory 450, which may be software in a form of a program, a plugin, and the like, including the following software modules: a feature obtaining module 4551, an information recommendation module 4552, an object determining module 4553, and a model training module 4554. The modules are logical. Therefore, the modules may be arbitrarily combined or further split based on to-be-implemented functions. Functions of the modules are described below.

In some embodiments, the data processing apparatus provided in the embodiments of this disclosure may be implemented through hardware. In an example, the data processing apparatus provided in the embodiments of this disclosure may be a processor in a form of a hardware decoding processor, which is programmed to perform the data processing method provided in the embodiments of this disclosure. For example, the processor in the form of the hardware decoding processor may be one or more application specific integrated circuits (ASICs), a DSP, a programmable logic device (PLD), a complex programmable logic device (CPLD), a field-programmable gate array (FPGA), or another electronic element.

The data processing method provided in the embodiments of this disclosure is described below with reference to exemplary applications and implementations of the data processing device provided in the embodiments of this disclosure. In addition, the data processing method provided in the embodiments of this disclosure is applicable to various information recommendation scenarios such as a cloud technology, artificial intelligence, intelligent transportation, and vehicles.

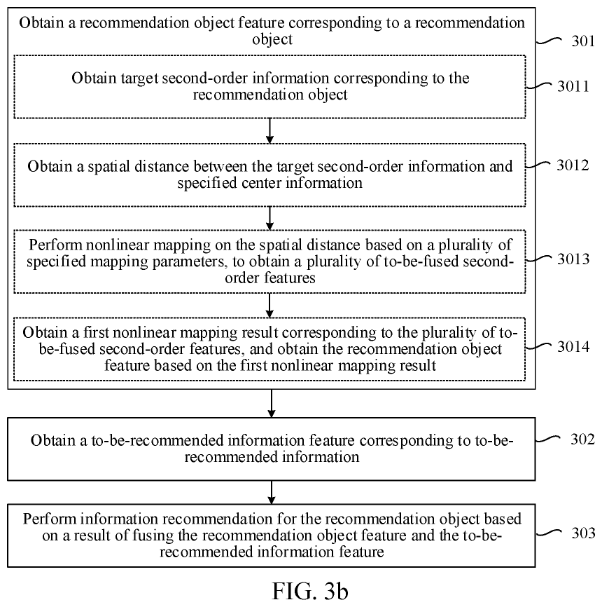

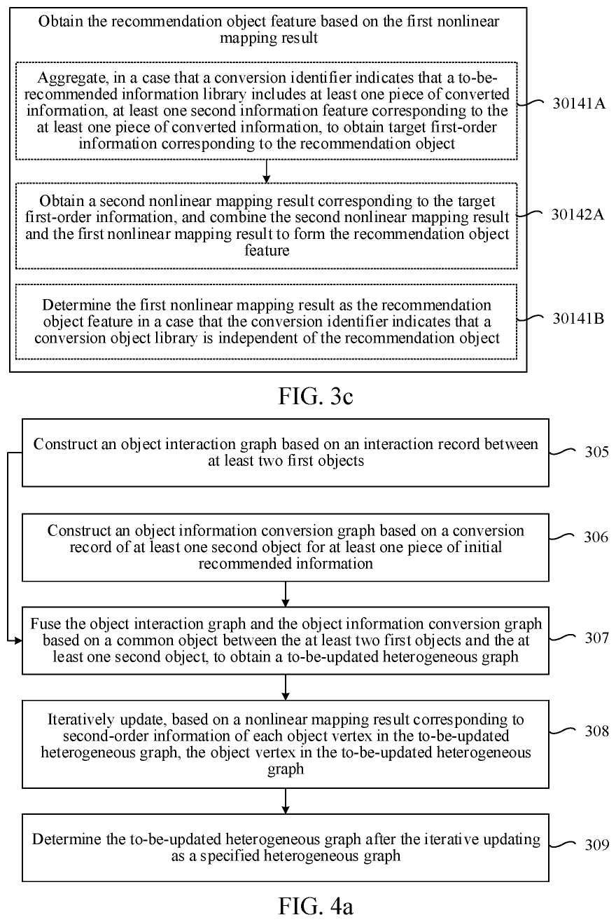

FIG. 3a is a first schematic flowchart of a data processing method according to an embodiment of this disclosure. A description is provided with reference to steps shown in FIG. 3a.

In step 301, a recommendation object feature corresponding to a recommendation object is obtained. In an example, new user feature information of a new user is determined based on a nonlinear mapping of target second-order information. For example, the target second-order information is determined based on current user feature information of at least one current user and first feature information of recommended information previously recommended to the at least one current user. The nonlinear mapping of the target second-order information is determined.

In this implementation of this disclosure, during information recommendation for the recommendation object, a data processing device first determines a feature representation associated with recommended information, that is, the recommendation object feature, for the recommendation object. The recommendation object feature is determined based on at least one interactive object. Each interactive object is an object with which the recommendation object interacts, and each interactive object converts at least one piece of recommended information.

The recommendation object feature herein may be determined in real time or predetermined, which is not limited in this embodiment of this disclosure. During determination of the recommendation object feature, the data processing device first obtains a feature representation of each interactive object (which is referred to as an object feature) and a feature representation of each piece of recommended information (which is referred to as a first information feature). In this case, the object feature corresponding to the at least one interactive object and the first information feature corresponding to the at least one piece of recommended information are obtained. Next, the data processing device aggregates the object feature corresponding to the at least one interactive object and the first information feature corresponding to the at least one piece of recommended information, so that target second-order information of the recommendation object is obtained. Finally, the data processing device performs nonlinear mapping on the target second-order information, so that the recommendation object feature is obtained. Moreover, the target second-order information may be iteratively obtained, and nonlinear mapping may be performed on the target second-order information, to obtain the recommendation object feature. The object feature may be an embedded representation of the interactive object, a one hot code of the interactive object, a feature representation corresponding to a label of the interactive object, or the like, which is not limited in this embodiment of this disclosure.

The recommendation object feature is a nonlinear mapping result corresponding to the target second-order information. The target second-order information is obtained by aggregating the object feature corresponding to the at least one interactive object and the first information feature corresponding to the at least one piece of recommended information. The at least one interactive object is an object configured to interact with the recommendation object. The at least one piece of recommended information is information converted by each interactive object. In addition, the nonlinear mapping is processing of enhancing a feature spatial dimensionality, for example, data processing based on a kernel function (such as a Gaussian kernel functions). A result after the nonlinear mapping has a higher feature spatial dimension compared to data before the nonlinear mapping. In other words, the target second-order information is a low-dimension feature, and the recommendation object feature is a high-dimension feature. In this way, the recommendation object can be effectively associated with each piece of recommended information, and similarity between the objects can be accurately determined. In addition, a field to which the recommendation object and the at least one interactive object belong may be the same as a field to which the at least one interactive object and the at least one piece of recommended information corresponding to each interactive object belong. For example, they all belong to a gaming field, an instant messaging field, or the like.

In step 302: A to-be-recommended information feature corresponding to to-be-recommended information is determined. In an example, to-be-recommended feature information corresponding to recommended information of the previously recommended information to be recommended to the new user is determined.

In this embodiment of this disclosure, the to-be-recommended information is any recommended information converted by the interactive object, that is, is any one of the at least one piece of recommended information converted by any interactive object. Herein, the data processing device obtains a feature representation of the to-be-recommended information, so that the to-be-recommended information feature is obtained.

The to-be-recommended information feature is used for determining whether the to-be-recommended information is information that can be recommended to the recommendation object. In addition, the to-be-recommended information feature may be an embedded representation of the to-be-recommended information, a one hot code of the to-be-recommended information, a feature representation corresponding to a label of the to-be-recommended information, or the like, which is not limited in this embodiment of this disclosure.

In step 303, Information recommendation for the recommendation object is performed based on a result of fusing the recommendation object feature and the to-be-recommended information feature. In an example, a recommendation for the new user is generated based on the new user feature information and the to-be-recommended feature information.

In this embodiment of the disclosure, after obtaining the recommendation object feature and the to-be-recommended information feature, the data processing device determines whether to recommend the to-be-recommended information to the recommendation object based on the recommendation object feature and the to-be-recommended information feature. The data processing device first fuses the recommendation object feature and the to-be-recommended information feature, and then processes the result of fusing the recommendation object feature and the to-be-recommended information feature by using an activation function (such as a Sigmoid function), so that a rate at which the recommendation object converts the to-be-recommended information is obtained. Therefore, it may be determined based on the rate at which the recommendation object converts the to-be-recommended information whether to recommend the to-be-recommended information to the recommendation object, to achieve information recommendation for the recommendation object.

It may be understood that, since the recommendation object feature of the recommendation object is determined based on the target second-order information, and the target second-order information is obtained by aggregating the object feature corresponding to the at least one interactive object and the first information feature corresponding to the at least one piece of recommended information, an association is established between the following information: interaction information between the objects and conversion information between the objects and the recommended information. In addition, since the recommendation object feature is obtained through nonlinear mapping of the target second-order information, effective interaction can be achieved between the object and the recommended information can be achieved, thereby improving the accuracy of information recommendation and reducing the resource consumption of information recommendation.

FIG. 3b is a second schematic flowchart of a data processing method according to an embodiment of this disclosure. As shown in FIG. 3b, in this embodiment of this disclosure, step 301 may be implemented through step 3011 to step 3014. In other words, obtaining the recommendation object feature corresponding to the recommendation object by the data processing device includes step 3011 to step 3014. The steps are described below.

In step 3011: Target second-order information corresponding to the recommendation object is obtained. In an example, target second-order information is determined based on current user feature information of at least one current user and first feature information of recommended information previously recommended to the at least one current user. For example, a nonlinear mapping of the target second-order information is determined. The new user feature information of a new user is determined based on the nonlinear mapping of the target second-order information.

In this embodiment of this disclosure, the data processing device can directly obtain the target second-order information by aggregating the object feature corresponding to the at least one interactive object and the first information feature corresponding to the at least one piece of recommended information. For example, the data processing device obtains a first accumulative result of the object feature corresponding to the at least one interactive object, obtains a second accumulative result of the first information feature corresponding to the at least one piece of recommended information, and accumulates the first accumulative result and the at least one second accumulative result corresponding to the at least one interactive object to obtain the target second-order information.

The data processing device can further aggregate the object feature corresponding to the at least one interactive object and the first information feature corresponding to the at least one piece of recommended information in combination with a weight, to obtain the target second-order information. To be specific, obtaining the target second-order information corresponding to the recommendation object by the data processing device includes: obtaining, by the data processing device, an interaction weight between the recommendation object and the interactive object, and obtaining a conversion weight between the interactive object and the recommended information; then obtaining, by the data processing device, a first fusion result of the interaction weight and the object feature and a second fusion result of the conversion weight and the first information feature; and combing at least one first fusion result corresponding to the at least one interactive object and at least one second fusion result corresponding to the at least one piece of recommended information converted by each interactive object, to form the target second-order information corresponding to the recommendation object.

The interaction weight is a weight between the recommendation object and the interactive object, which represents intimacy between the recommendation object and the interactive object. The data processing device can determine the intimacy between the recommendation object and the interactive object through at least one of the following information: an interaction quantity, an interaction duration, interaction frequency, and an interaction manner. The conversion weight is a weight between the interactive object and the recommended information, which represents a conversion degree between the interactive object and the recommended information. The data processing device can determine the conversion degree between the interactive object and the recommended information through at least one of the following information: a conversion quantity, a conversion duration, conversion frequency, and a conversion manner (such as click-through, placing an order, browse, playback, and becoming a fan of others). Herein, the data processing device fuses the interaction weight and the object feature of the interactive object corresponding to the interaction weight, so that the first fusion result is fused. In this way, at least one first fusion result is obtained for the at least one interactive object. The data processing device fuses the conversion weight and the first information feature of the corresponding recommended information, so that the second fusion result is obtained. In this way, at least one second fusion result is obtained for the at least one piece of recommended information. In other words, each interactive object corresponds to at least one second fusion result. In addition, the combination for forming the target second-order information may be addition, splicing, weighted fusion, or the like, which is not limited in this embodiment of this disclosure.

The first accumulative result is obtained by the data processing device by directly accumulating the at least one object feature corresponding to the at least one interactive object. The first fusion result is obtained by the data processing device by performing weighted accumulation on the at least one object feature based on the intimacy between the recommendation object and the interactive object. The second accumulative result is obtained by the data processing device by directly accumulating the at least one first information feature corresponding to the at least one piece of recommended information. The second fusion result is obtained by the data processing device by performing weighted accumulation on the at least one first information feature based on the conversion degree between the interactive object and the recommended information.

It may be understood that, by obtaining the target second-order information by combining the weights and then obtaining the recommendation object feature through the target second-order information, accuracy of obtaining the target second-order information can be improved, and accuracy of the recommendation object feature can be improved, so that the recommendation object feature can be effectively associated with the to-be-recommended information, thereby improving the accuracy of information recommendation.

In step 3012: A spatial distance between the target second-order information and specified center information is obtained.

The data processing device can obtain the specified center information. The specified center information is determined through a plurality of pieces of second-order information. The plurality of pieces of second-order information includes the target second-order information. In addition to the target second-order information, the plurality of pieces of second-order information further includes other second-order information. The other second-order information may be second-order information corresponding to the at least one interactive object. For example, the specified center information is an average of the plurality of pieces of second-order information. In addition, the second-order information is a result of aggregating the feature of the object with which the object interacts and the feature of the information converted by each object with which the object interacts.

In this embodiment of this disclosure, the data processing device obtains a feature difference between the target second-order information and the specified center information, and determines the feature difference as the spatial distance, such as a Euclidean distance, between the target second-order information and the specified center information.

In step 3013: Nonlinear mapping on the spatial distance is performed based on a plurality of specified mapping parameters, to obtain a plurality of to-be-fused second-order features.

The data processing device can obtain multiple a plurality of specified mapping parameters. The specified mapping parameters each represent a mapping space range, such as a Gaussian bandwidth. Herein, the data processing device performs nonlinear mapping on the spatial distance by using each specified mapping parameter, to map the spatial distance to different mapping space ranges. In this way, a plurality of to-be-fused second-order features can be obtained for a plurality of specified mapping parameters. In addition, each to-be-fused second-order feature is a result obtained by performing nonlinear mapping based on the corresponding specified mapping parameter.

In step 3014: A first nonlinear mapping result corresponding to the plurality of to-be-fused second-order features is obtained, and the recommendation object feature is obtained based on the first nonlinear mapping result. In an example, to-be-combined second-order feature information is determined based on the nonlinear mapping, the nonlinear mapping being based on the spatial distance and a plurality of mapping parameters, each of the plurality of mapping parameters representing a mapping space range, wherein the nonlinear mapping of the target second-order information includes a first nonlinear mapping of a plurality of to-be-combined second-order features in the to-be-combined second-order feature information.

In this embodiment of this disclosure, after obtaining the plurality of to-be-fused second-order features, the data processing device integrates the plurality of to-be-fused second-order features to obtain the first nonlinear mapping result. Herein, the data processing device can directly determine the first nonlinear mapping result as the recommendation object feature, or combine the first nonlinear mapping result and other information (such as the information converted by the recommendation object) to form the recommendation object feature, which is not limited in this embodiment of this disclosure. Therefore, the nonlinear mapping result corresponding to the target second-order information includes at least the first nonlinear mapping result.

In this embodiment of this disclosure, before step 301 in which the data processing device obtains the recommendation object feature corresponding to the recommendation object, the data processing method further includes: obtaining, by the data processing device, a conversion identifier of the recommendation object for a to-be-recommended information library.

The to-be-recommended information library includes the at least one piece of recommended information converted by each of the at least one interactive object. The data processing device detects a status of conversion of each piece of recommended information in the to-be-recommended information library by the recommendation object, to obtain the conversion identifier. The conversion identifier indicates whether the recommendation object converts the recommended information in the to-be-recommended information library.

Correspondingly, FIG. 3c is a schematic flowchart of obtaining a recommendation object feature according to an embodiment of this disclosure. As shown in FIG. 3c, in this embodiment of this disclosure, step 3014 of obtaining the recommendation object feature by the data processing device based on the first nonlinear mapping result includes step 30141A and step 30142A. The steps are described below.

In step 30141A: In a case that the conversion identifier indicates that the to-be-recommended information library includes at least one piece of converted information, at least one second information feature corresponding to the at least one piece of converted information is aggregated, to obtain target first-order information corresponding to the recommendation object. In an example, a conversion identifier of the new user for a to-be-recommended information library is determined, the to-be-recommended information library including the previously recommended information converted by the at least one current user. For example, the target first-order information of the new user is determined when the conversion identifier indicates that the to-be-recommended information library includes the converted information, based on a second feature information corresponding to the converted information, the converted information being recommended information converted by the new user, and the second feature being of the converted information.

When the conversion identifier indicates that the to-be-recommended information library includes at least one piece of converted information corresponding to the recommendation object, it indicates that the recommendation object converts the recommended information in the to-be-recommended information library, and the converted recommended information is at least one piece of converted information. Therefore, the recommendation object is a non-cold start object. Each piece of converted information is recommended information in the to-be-recommended information library converted by the recommendation object. In this case, the association between the recommendation object and the recommended information may be established through the at least one piece of converted information converted by the recommendation object. The data processing device aggregates the second information feature corresponding to the at least one piece of converted information, so that the target first-order information corresponding to the recommendation object is obtained. In other words, the target first-order information is obtained by aggregating the second information feature corresponding to the at least one piece of converted information. Herein, the second information feature is a feature of the converted information.

In step 30142A: A second nonlinear mapping result corresponding to the target first-order information is obtained, and the second nonlinear mapping result and the first nonlinear mapping result to form the recommendation object feature is combined. In an example, a second nonlinear mapping of the target first-order information is determined, wherein the determining the new user feature information includes combining the second nonlinear mapping and the first nonlinear mapping.

In this embodiment of this disclosure, the data processing device performs nonlinear mapping on the target first-order information, to obtain the second nonlinear mapping result. A process of performing the nonlinear mapping on the target first-order information by the data processing device is similar to the process of performing the nonlinear mapping on the target second-order information, which is not described herein in this embodiment of this disclosure. Herein, the data processing device combines the first nonlinear mapping result and the second nonlinear mapping result, so that the recommendation object feature is obtained. The combination may be addition, weighted addition, or the like. Moreover, in the process of combining the first nonlinear mapping result and the other information to obtain the recommendation object feature, the other information that is combined is the second nonlinear mapping result.

It may be understood that, when the recommendation object is a non-cold start object, in the process of obtaining the recommendation object feature based on the target second-order information, not only the first nonlinear mapping result corresponding to the target second-order information is used, but also the second nonlinear mapping result corresponding to the target first-order information is used, which improves diversity of the data used for obtaining the recommendation object feature, thereby improving the recommendation object feature, improving the accuracy of information recommendation, and reducing the resource consumption of information recommendation.

In this embodiment of this disclosure, step 30142A of combining the second nonlinear mapping result and the first nonlinear mapping result by the data processing device to form the recommendation object feature corresponding to the recommendation object includes: combining, by the data processing device, the second nonlinear mapping result and the first nonlinear mapping result to obtain initial aggregation information; obtaining a first combination weight negatively correlated with the initial aggregation information and positively correlated with the second nonlinear mapping result, and obtaining a second combination weight corresponding to the first combination weight; and combining a third fusion result and a fourth fusion result to obtain the recommendation object feature. The third fusion result is a result of fusing the first combination weight and the second nonlinear mapping result, and the fourth fusion result is a result of fusing the second combination weight and the first nonlinear mapping result.

The data processing device can combine the first nonlinear mapping result and the second nonlinear mapping result by adding them together to obtain the initial aggregation information. In addition, the first combination weight is negatively correlated with the second combination weight. For example, the first combination weight is a difference between 1 and the second combination weight. Moreover, the data processing device can combine the third fusion result and the fourth fusion result by adding them together to obtain the recommendation object feature.

Still referring to FIG. 3c, in this embodiment of this disclosure, step 3014 of obtaining the recommendation object feature by the data processing device based on the first nonlinear mapping result includes step 30141B. The step is described below.

In step 30141B: The first nonlinear mapping result as the recommendation object feature is determined in a case that the conversion identifier indicates that a conversion object library is independent of the recommendation object.

When the conversion identifier indicates that the conversion object library corresponding to the to-be-recommended information library is independent of the recommendation object, it indicates that the recommendation object does not convert the recommended information in the to-be-recommended information library. In this case, the recommendation object is a cold start object. In other words, the recommendation object does not belong to the conversion object library. The conversion object library is a set of objects that convert the to-be-recommended information in the to-be-recommended information library. In this case, the association between the recommendation object and the recommended information is obtained through the first nonlinear mapping result of the target second-order information.

In this embodiment of this disclosure, the recommendation object feature and the to-be-recommended information feature are obtained through a specified heterogeneous graph. In the specified heterogeneous graph, a vertex is the feature of the object (including the recommendation object and the at least one interactive object) or the feature of the recommended information (including the at least one piece of recommended information corresponding to each interactive object), and an edge is an edge between the objects or between the object and the recommended information. The edge may be a weighted edge or an unweighted edge. When the edge is a weighted edge, a weight of the edge represents a degree of association between two vertices, such as the intimacy between the objects and the conversion degree between the object and the recommended information. The feature of the object is obtained by aggregating the features of the recommended information converted by the associated object.

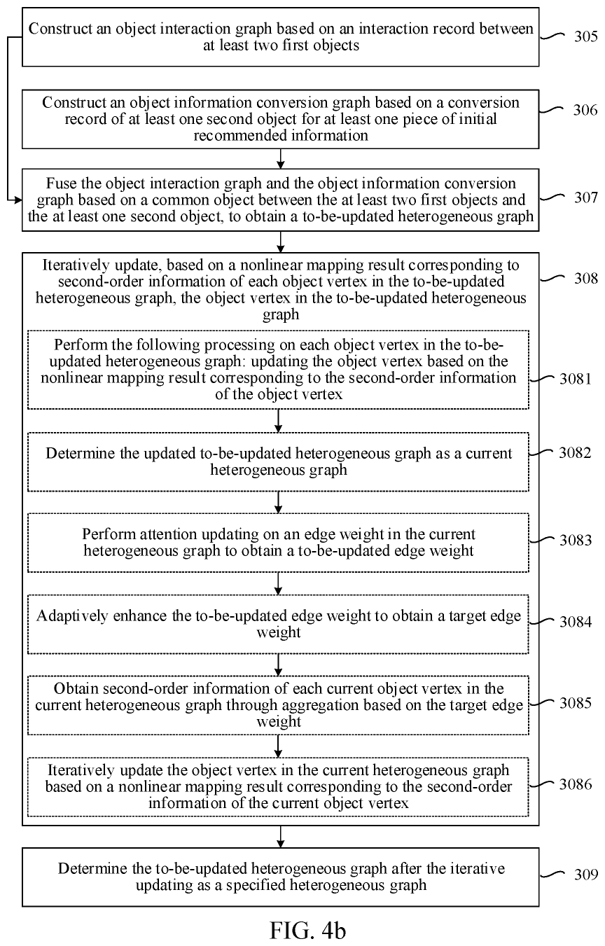

FIG. 4a is a first schematic flowchart of model training according to an embodiment of this disclosure. As shown in FIG. 4a, the specified heterogeneous graph is obtained through step 305 to step 309. The steps are described below.

In step 305: A object interaction graph is constructed based on an interaction record between at least two first objects. In an example, a user interaction graph is constructed based on an interaction record between at least two first users, the at least two first users including the new user and the at least one current user.

The at least two first objects include the recommendation object and the at least one interactive object. In the object interaction graph constructed by the data processing device, a vertex is a feature representation of the first object, and an edge represent interaction between two first objects. When the edge is a weighted edge, a weight of the edge represents intimacy determined based on interaction information (such as an interaction quantity, interaction frequency, and an interaction type) between the two first objects.

In step 306: An object information conversion graph is constructed based on a conversion record for at least one second object to at least one piece of initial recommended information. In an example, a user information conversion graph is constructed based on a conversion record of at least one second user for initial recommended information, the initial recommended information including the recommended information converted by the at least one current user.

The at least one piece of initial recommended information includes the at least one piece of recommended information converted by each interactive object. In the object information conversion graph constructed by the data processing device, a vertex represents a feature representation of the second object or a feature representation of the initial recommended information, and an edge indicates that the second object converts the initial recommended information. When the edge is a weighted edge, a weight corresponding to the edge represents a conversion degree determined based on conversion information (such as a conversion quantity, a conversion duration, conversion frequency, and a conversion type) of the second object to the initial recommended information.

In step 307: Fuse the object interaction graph and the object information conversion graph based on a common object between the at least two first objects and the at least one second object, to obtain a to-be-updated heterogeneous graph. In an example, a to-be-updated heterogenous graph is generated based on the user interaction graph and the user information conversion graph according to a common user between the at least two first users and the at least one second user.

In this embodiment of this disclosure, after obtaining the object interaction graph and the object information conversion graph, the data processing device first obtains the common object between the at least two first objects and the at least one second object, and then combines relevant information of the first object associated with the common object in the object interaction graph through the edge and relevant information of the initial recommended information associated with the common object in the object information conversion graph through the edge, so that to-be-updated heterogeneous graph is obtained. In other words, the to-be-updated heterogeneous graph includes not only an interaction relationship between the common object and the first object with which the common object interacts, but also a conversion relationship between the common object and the converted initial recommended information.

In step 308: Based on a nonlinear mapping result corresponding to second-order information of each object vertex in the to-be-updated heterogeneous graph, the object vertex in the to-be-updated heterogeneous graph is iteratively updated. In an example, each user vertex in the to-be-updated heterogeneous graph is iteratively updated based on a nonlinear mapping corresponding to second-order information of the respective user vertex in the to-be-updated heterogeneous graph.

In this embodiment of this disclosure, vertices in the to-be-updated heterogeneous graph include some object vertices and some information vertices. An object vertex is a feature representation of the first object or the second object, and an information vertex is the feature representation of the initial recommended information. Herein, the data processing device iteratively updates the object vertices of the to-be-updated heterogeneous graph, to update the to-be-updated heterogeneous graph. The data processing device updates, based on the nonlinear mapping result corresponding to the second-order information of each object vertex, the corresponding object vertex.

The second-order information of each object vertex includes an object vertex corresponding to an object interacting with the object vertex interacts and an information vertex corresponding to initial recommended information converted by the object with which the object vertex interacts. In addition, the second-order information in this embodiment of this disclosure is obtained by aggregating a feature of the object with which the object interacts and a feature of the recommended information converted by the object with which the object interacts. Therefore, the target second-order information is the second-order information of the recommendation object.

In step 309: The to-be-updated heterogeneous graph is determined after the iterative updating as a specified heterogeneous graph.

In this embodiment of the disclosure, the data processing device iteratively updates the to-be-updated heterogeneous graph. When the to-be-updated heterogeneous graph after the iterative updating reaches a specified ending condition, the iteration updating ends, and the to-be-updated heterogeneous graph after the iterative updating is determined as the specified heterogeneous graph. The specified ending condition means that the to-be-updated heterogeneous graph after current iterative updating reaches a specified indicator. For example, accuracy of the heterogeneous graph is greater than a specified accuracy, a loss function value of the heterogeneous graph is less than a specified loss function value, or an area under curve (AUC) of the heterogeneous graph is greater than a specified area.

FIG. 4b is a second schematic flowchart of model training according to an embodiment of this disclosure. As shown in FIG. 4b, in this embodiment of this disclosure, step 308 may be implemented through step 3081 to step 3086 (not shown in the figure). In other words, iteratively updating, by the data processing device based on the nonlinear mapping result corresponding to the second-order information of each object vertex in the to-be-updated heterogeneous graph, the object vertex in the to-be-updated heterogeneous graph includes step 3081 to step 3086. The steps are described below.

In step 3081: The following processing is performed on each object vertex in the to-be-updated heterogeneous graph: updating the object vertex based on the nonlinear mapping result corresponding to the second-order information of the object vertex. In an example, the each user vertex in the to-be-updated heterogeneous graph is updated based on the nonlinear mapping of the second-order information of the respective user vertex.

In step 3082: The updated to-be-updated heterogeneous graph is determined as a current heterogeneous graph.

A process of obtaining the second-order information of each object vertex in the to-be-updated heterogeneous graph by the data processing device is similar to the process of obtaining target second-order information. Moreover, a process of obtaining the nonlinear mapping result corresponding to the second-order information of each object vertex in the to-be-updated heterogeneous graph by the data processing device is similar to the process of obtaining the nonlinear mapping result corresponding to the target second-order information. A process of updating the object vertex in the to-be-updated heterogeneous graph by the data processing device is similar to the process of obtaining the recommendation object feature based on the nonlinear mapping result corresponding to the target second-order information. The processes are not described herein in this embodiment of this disclosure.

In step 3083: Attention updating is performed on an edge weight in the current heterogeneous graph to obtain a to-be-updated edge weight. In an example, attention updating is performed on an edge weight in the updated to-be-updated heterogeneous graph to determine a to-be-updated edge weight.

In this embodiment of this disclosure, performing attention updating on the edge weight in the current heterogeneous graph by the data processing device to obtain the to-be-updated edge weight includes: performing, by the data processing device, the following processing on each current object vertex in the current heterogeneous graph: obtaining at least one adjacent object vertex corresponding to the current object vertex, the adjacent object vertex being an object vertex adjacent to the current object vertex; determining an attention interaction weight between the current object vertex and each adjacent object vertex based on the at least one adjacent object vertex; obtaining at least one adjacent information vertex corresponding to the current object vertex, the adjacent information vertex being an information vertex adjacent to the current object vertex; and determining an attention conversion weight between the current object vertex and each adjacent information vertex based on the at least one adjacent information vertex, the to-be-updated edge weight being the attention interaction weight or the attention conversion weight.

The data processing device determines, for each adjacent object vertex in the at least one adjacent object vertex, the attention interaction weight based on a proportion of the adjacent object vertex in the at least one adjacent object vertex. In other words, the attention interaction weight is the proportion of each adjacent object vertex in the at least one adjacent object vertex. The data processing device determines, for each adjacent information vertex in the at least one adjacent object vertex, the attention conversion weight based on a proportion of the adjacent information vertex in the at least one adjacent information vertex. In other words, the attention conversion weight is the proportion of each adjacent information vertex in the at least one adjacent information vertex.

In step 3084: The to-be-updated edge weight is adaptively enhanced to obtain a target edge weight. For example, a target edge weight is obtained based on the to-be-updated edge weight.

In this embodiment of this disclosure, adaptively enhancing the to-be-updated edge weight by the data processing device to obtain the target edge weight includes: obtaining, by the data processing device, at least one to-be-updated edge weight, the at least one to-be-updated edge weight being adjacent to a target to-be-updated edge weight and having a type different from that of the target to-be-updated edge weight, and the target to-be-updated edge weight being any to-be-updated edge weight to be adaptively enhanced; and enhancing the target to-be-updated edge weight based on the at least one to-be-updated edge weight, to obtain the target edge weight.

When the target to-be-updated edge weight is the attention interaction weight, the data processing device obtains at least one attention conversion weight adjacent to the attention interaction weight, superimposes each attention conversion weight with the attention interaction weight, to obtain a first weight superimposition sum. Next, the data processing device determines a first enhancement parameter negatively correlated with the first weight superimposition sum and positively correlated with the attention conversion weight, and obtains a first enhancement weight by fusing the first enhancement parameter and the corresponding attention conversion weight. Finally, the data processing device superimposes the attention interaction weight with at least one first enhancement weight corresponding to the at least one attention conversion weight to obtain a target to-be-updated edge weight after updating, that is, the target edge weight in the current heterogeneous graph.

When the target to-be-updated edge weight is the attention conversion weight, the data processing device obtains at least one attention interaction weight adjacent to the attention conversion weight, superimposes each attention interaction weight with the attention conversion weight, to obtain a second weight superimposition sum. Next, the data processing device determines a second enhancement parameter negatively correlated with the second weight superimposition sum and positively correlated with the attention interaction weight, and obtains a second enhancement weight by fusing the second enhancement parameter and the corresponding attention interaction weight. Finally, the data processing device superimposes the attention conversion weight with at least one second enhancement weight corresponding to the at least one attention interaction weight to obtain a target to-be-updated edge weight after updating, that is, the target edge weight in the current heterogeneous graph.

In step 3085: second-order information of each current object vertex is obtained in the current heterogeneous graph through aggregation based on the target edge weight. In an example, second-order information of each current user vertex is determined in the current heterogeneous graph through aggregation based on the target edge weight.

A process of obtaining the second-order information of each current object vertex in the current heterogeneous graph by the data processing device based on the target edge weight is similar to the process of combining the interaction weight and the conversion weight by the data processing device to obtain the target second-order information, which is not described herein in this embodiment of this disclosure.

In step 3086: The object vertex in the current heterogeneous graph is iteratively updated based on a nonlinear mapping result corresponding to the second-order information of the current object vertex. In an example, the each current user vertex in the current heterogeneous graph is iteratively updated based on a nonlinear mapping corresponding to the second-order information of the respective current user vertex.

In this embodiment of this disclosure, the process of iteratively updating the current heterogeneous graph by the data processing device is similar to the process of iteratively updating the heterogeneous graph, which is not described herein in this embodiment of this disclosure.

In this embodiment of this disclosure, step 303 of performing information recommendation for the recommendation object by the data processing device based on the result of fusing the recommendation object feature and the to-be-recommended information feature includes: determining, by the data processing device based on the result of fusing the recommendation object feature and to-be-recommended information feature, a CVR that the recommendation object converts the to-be-recommended information; sorting, in a case that the to-be-recommended information library includes at least two pieces of to-be-recommended information, the at least two pieces of to-be-recommended information in a reverse order based on at least two CVRs of the recommendation object for the at least two pieces of to-be-recommended information, to obtain a to-be-recommended information sequence; determining a specified quantity of to-be-recommended information successively selected from the to-be-recommended information sequence as target to-be-recommended information; and recommending the target to-be-recommended information to the recommendation object. The specified quantity is at least one.

The data processing device can further compare the CVR with a specified rate, and recommends the to-be-recommended information to the recommendation object when the CVR is greater than the specified rate.

In this embodiment of this disclosure, during the iterative updating of the to-be-updated heterogeneous graph, the object vertex in the heterogeneous graph may be updated, or all vertices (including the object vertex and the information vertex) in the heterogeneous graph may be updated, which is not limited in this embodiment of this disclosure. Moreover, the process of updating information vertex in the heterogeneous graph by the data processing device is similar to the process of updating the object vertex, which is not described herein in this embodiment of this disclosure.

An exemplary application of this embodiment of this disclosure in an actual application scenario is described below. The exemplary application is performed by a server (which is referred to as a data processing device), which describes the following: In a gaming field, an “account advertisement” click-through bipartite graph (which is referred to as an object information conversion graph) is constructed based on a historical click-through situation between accounts and advertisements in historical recommendation data, an “account-account” social graph (which is referred to as an object interaction graph) is constructed based on an interaction situation between accounts, then a heterogeneous graph (which is referred to as a to-be-updated heterogeneous graph) is obtained by fusing the click-through bipartite graph and the social graph, and heterogeneous information aggregation is performed on vertices in the heterogeneous graph corresponding to the accounts to achieve information interaction between cold start accounts and advertisements. In this way, accuracy of information recommendation can be improved for the cold start accounts.

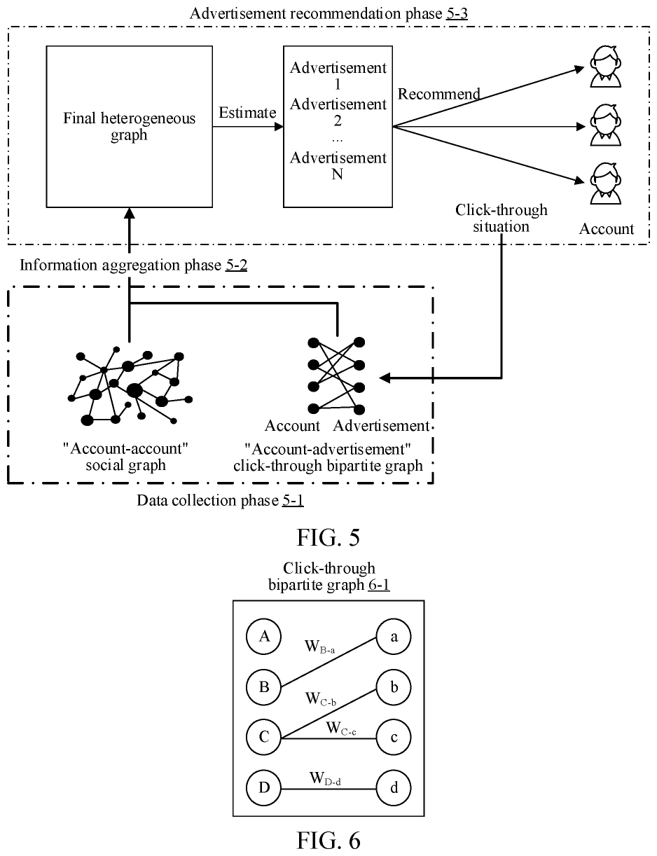

FIG. 5 is a schematic diagram of an exemplary information recommendation process according to an embodiment of this disclosure. As shown in FIG. 5, the exemplary information recommendation process includes a data collection phase 5-1, an information aggregation phase 5-2, and an advertisement recommendation phase 5-3.

In the data collection phase 5-1, historical recommendation data of advertisements in a gaming field is collected, data about click-through of advertisements by accounts (which is referred to as an interaction record) is extracted from the historical recommendation data, and an “account-advertisement” click-through bipartite graph is constructed based on the data about click-through of the advertisements by the account. In the click-through bipartite graph, a vertex is a vector representation (which is referred to as a feature representation) of an account (which is referred to as a second object) or an advertisement (which is referred to as initial recommended information), an edge between vertices represents click-through of the account on the advertisement, and a weight of the edge represents a conversion relationship between the account and the advertisement. For example, the weight of the edge is positively correlated with a quantity of times the account clicks the advertisement or a duration of consumption.

FIG. 6 is a schematic diagram of an exemplary click-through bipartite graph according to an embodiment of this disclosure. As shown in FIG. 6, in a click-through bipartite graph 6-1, vertices A, B, C, and D represent account vector representations, and vertices a, b, c, and d represent advertisement vector representations. A connection between the vertex B and the vertex a is used as an example for description herein. An account corresponding to the vertex B clicks an advertisement corresponding to the vertex a, so that an edge exists between the vertex B and the vertex a, and a weight corresponding to that edge is W_{B-a}. In addition, the vertex A has no edge with the vertices a, b, c, and d, which is an isolated vertex in the click-through bipartite graph 6-1. Therefore, an account corresponding to the vertex A is a cold start account (which is referred to as a cold start object). Accounts corresponding to the vertices B, C, and D are non-cold start accounts (which are referred to as non-cold start objects).

In the data collection phase 5-1, historical social data (which is referred to as a conversion record) in the gaming field is further collected, and an “account-account” social graph is constructed based on the historical social data. In a social graph, a vertex (which is referred to as a first object) is an account vector representation, an edge between vertices represents interaction between two accounts, such as exchanging virtual resources, teaming up for gaming, and communication, and a weight of the edge represents interaction intimacy between the two accounts.

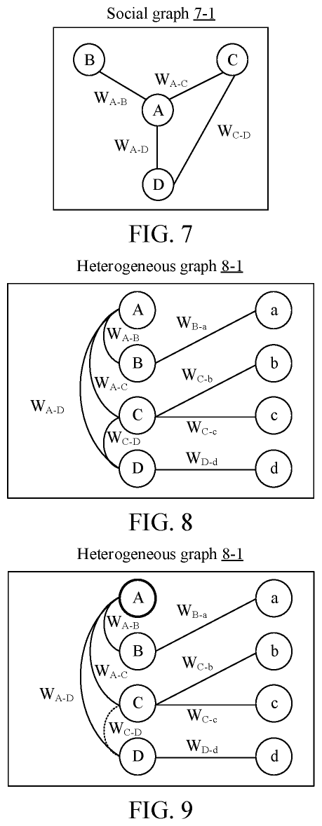

FIG. 7 is a schematic diagram of an exemplary social graph according to an embodiment of this disclosure. As shown in FIG. 7, in a social graph 7-1, vertices A, B, C, and D are account vector representations. Connections between the vertex A and the vertices B, C, and D are used as an example for description. An account corresponding to the vertex A interacts with accounts corresponding to the vertices B, C, and D, so that an edge exists between the vertex A and each of the vertices B, C, and D, and weights corresponding to the edges are respectively W_{A-B}, W_{A-C}, and W_{A-D}. In addition, a weight between the vertex C and the vertex D is W_{C-D}.

In the information aggregation phase 5-2, the click-through bipartite graph and the social graph are fused first to obtain a heterogeneous graph (which is referred to as a to-be-updated heterogeneous graph). In a heterogeneous graph G= [symbol] V, E, W [symbol] a vertex V represents a vector˜ ˜ se compose v Perset a˜U˜L˜ n vector set composed of vector representations correspon ing to ecunts and M e e s, and a weight W represents a scalar set composed of weights between accounts and between accounts and advertisements. Since the heterogeneous graph is obtained by fusing two subgraphs, that is, a click-through bipartite graph G^{B} and a social graph G^{S}, the heterogeneous graph G may alternatively be represented as G= [symbol] G^{B}, G^{S} [symbol] , U is a A mVrset of account vector [symbol] representations in the click-through bipartite graph G^{B}, u is an individual of the account vector representations, and u∈U. I is a universal set of advertisement vector representations in the social graph G^{S}, i is an individual of the advertisement vector representations, and i∈I. Therefore, a vertex, an edge, and an edge weight (which is referred to as a conversion weight) of the click-through bipartite graph may be successively represented as uₘ or iₙ, uₘ⇄iₙ, and w_{m,n}, and a vertex, an edge, and an edge weight (which is referred to as an interaction weight) of the social graph may be successively represented as Uₘ, uₘ₁⇄uₘ₂, W_{m1,m2}. m represents an account index, and n represents an advertisement index.

FIG. 8 is a schematic diagram of an exemplary heterogeneous graph according to an embodiment of this disclosure. As shown in FIG. 8, a heterogeneous graph 8-1 is obtained by fusing the click-through bipartite graph 6-1 in FIG. 6 and the social graph 7-1 in FIG. 7. In the heterogeneous graph 8-1, an association can be established between the vertex A and the vertices a, b, c, and d through the vertices B, C, and D. Therefore, the heterogeneous graph reflects an association between a cold start account and an advertisement.

Finally, heterogeneous information aggregation is performed on the vertices in the heterogeneous graph corresponding to the accounts, including heterogeneous information aggregation on cold start accounts and heterogeneous information aggregation on non-cold start accounts. During the heterogeneous information aggregation on the cold start accounts, second-order information of the vertices is used for the heterogeneous information aggregation. During the heterogeneous information aggregation on the non-cold start accounts, first-order information and second-order information of the vertices are used for the heterogeneous information aggregation. The first-order information may be implemented through a formula (1), which is shown as follows.

$${V}_{u}^{B} = {\sum }_{i = 0}^{I} {w}_{u , i} \cdot {V}_{i}^{B} . \qquad ( 1 )$$

Vᵤ^{B} represents first-order information of a vertex corresponding to an account u, w_{u,i} represents a weight between the account u and an advertisement i, and Vᵢ^{B} represents a vector representation of the advertisement i.

The second-order information may be implemented through a formula (2), which is shown as follows.

$${V}_{u}^{s} = {\sum }_{{u}^{′} = 0 \& u \neq {u}^{′}}^{U} {w}_{u , {u}^{′}} \cdot {V}_{{u}^{′}}^{S} + {\sum }_{i = 0}^{I} {w}_{{u}^{′} , i} \cdot {V}_{i}^{B} . \qquad ( 2 )$$

Vᵤ^{s} represents second-order information of the vertex corresponding to the account u, V_{u′}^{s} represents a vector representation of an account u′, w_{u,u′} represents a weight between the account u and the account u′, and w_{u′i} represents a weight between the account u′ and the advertisement i.

FIG. 9 is a schematic diagram of exemplary heterogeneous information aggregation according to an embodiment of this disclosure. As shown in FIG. 9, for the vertex A in the heterogeneous graph 8-1 in FIG. 8 corresponding to the cold start account, corresponding second-order information may be expressed as [vertex A-vertex B-vertex a; vertex A-vertex C-vertex b; vertex A-vertex C-vertex c; vertex A-vertex D-vertex d], as shown by solid lines in FIG. 9.

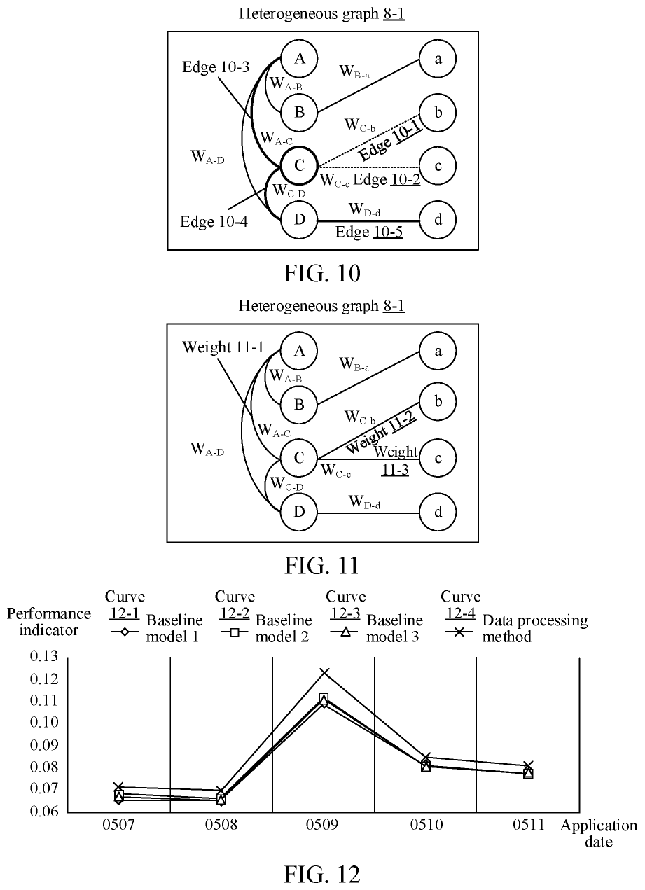

FIG. 10 is schematic diagram of another exemplary heterogeneous information aggregation according to an embodiment of this disclosure. As shown in FIG. 10, for the vertex C in the heterogeneous graph 8-1 in FIG. 8 corresponding to the non-cold start account, corresponding first-order information may be expressed as [vertex C-vertex b; vertex C-vertex c], as shown by an edge 10-1 and an edge 10-2 in FIG. 10, and second-order information may be expressed as [vertex C-vertex A; vertex C-vertex D-vertex d], as shown by an edge 10-3, an edge 10-4, and an edge 10-5 in FIG. 10.

Since the information involved in the heterogeneous information aggregation originates from two different subgraph structures, a multi-band Gaussian kernel function is used herein to achieve the heterogeneous information aggregation. A result V, of the heterogeneous information aggregation may be implemented through a formula (3), which is shown as follows.

$${V}_{u} = α \cdot {\sum }_{k = 0}^{K} {φ}_{k} ( {V}_{u}^{B} ) + ( 1 - α ) \cdot {\sum }_{k = 0}^{K} {φ}_{k} ( {V}_{u}^{s} ) . \qquad ( 3 )$$

k represents an index value of a Gaussian bandwidth, K represents a set of a plurality of Gaussian bandwidths (which are referred to as a plurality of specified mapping parameters), and φₖ( ) represents the Gaussian kernel function. φₖ(Vᵤ^{B}) is used as an example for description herein. φₖ(Vᵤ^{B}) may be implemented through a formula (4). 1-a is referred to as a second combination weight. a (which is referred to as a first combination weight) may be implemented through a formula (5). The formula (4) and the formula (5) are shown as follows.

$${φ}_{k} ( {V}_{u}^{B} ) = exp ( - \frac{{‖ {V}_{u}^{B} - \overline{{V}_{u}^{B}} ‖}^{2}}{2 {σ}_{k}} ) . \qquad ( 4 )$$

σₖ represents a k^{th} Gaussian bandwidth parameter, and V, represents a center of the Gaussian kernel function.

$$α = \frac{\sum {\sum }_{k = 0}^{K} {φ}_{k} ( {V}_{u}^{B} )}{\sum {\sum }_{k = 0}^{K} {φ}_{k} ( {V}_{u}^{B} ) + \sum {\sum }_{k = 0}^{K} {φ}_{k} ( {V}_{u}^{s} )} . \qquad ( 5 )$$

During the heterogeneous information aggregation for the cold start accounts, since the first-order information is not involved, a value of a in the formula (3) is 0.

In this embodiment of this disclosure, after a heterogeneous information aggregation is completed, weight updating is performed. Since the heterogeneous graph originates from two different types of subgraphs (the click-through bipartite graph and the social graph), and the two different types of subgraphs are heterogeneous information, weight updating is performed by using adaptive weighting and attention mechanisms. In other words, weight updating is performed on each subgraph by using an attention mechanism, and then the weights on different subgraphs are fused by using an adaptive weighting mechanism. A process of updating a weight w_{u,i}^{B}; of an edge in the heterogeneous graph belonging to the click-through bipartite graph by using the attention mechanism is shown by a formula (6).

$${w}_{u , i}^{B} = \frac{exp ( Leaky Re LU ( {V}_{i}^{B} ) )}{{\sum }_{{i}^{′} ∈ Neighbor ( I )} exp ( Leaky Re LU ( {V}_{{i}^{′}}^{B} ) )} . \qquad ( 6 )$$

LeakyReLU represents an activation layer function ( ); Neighbor(I) represents a set of vector representations of all advertisements clicked by the account u, which is referred to as at least one adjacent information vertex corresponding to a current object vertex, and i′∈ Neighbor(I); and V_{i′}^{B} represents a vector representation of an advertisement i′.

A process of updating a weight of an edge in the heterogeneous graph belonging to the social graph by using the attention mechanism is shown by a formula (7).

$${w}_{u , u ′}^{S} = \frac{exp ( Leaky Re LU ( {V}_{{u}^{′}}^{s} ) )}{{\sum }_{{u}^{′} ∈ Neighbor ( U )} exp ( Leaky Re LU ( {V}_{u ′}^{B} ) )} . \qquad ( 7 )$$

Neighbor(U) represents a set of vector representations of all accounts with which the account u interacts, which is referred to as at least one adjacent object vertex corresponding to the current object vertex, and u′∈ Neighbor(U); V_{u′}^{B} represents a vector representation of the account u′; w_{u,i}^{B}is referred to as an attention conversion weight; and w_{u,u′}^{s} is referred to as an attention interaction weight.

A process of fusing the weights from different subgraphs by using the adaptive weighting mechanism is shown by a formula (8) and a formula (9).

$${w}_{u , i} = {w}_{u , i}^{B} + β \cdot {w}_{u , {u}^{′}}^{S} ; β = \frac{{w}_{u , u ′}^{S}}{{w}_{u , u ′}^{S} + {w}_{u , i}^{B}} . \qquad ( 8 )$$

$${w}_{u , {u}^{′}} = {w}_{u , {u}^{′}}^{S} + γ \cdot {w}_{u , i}^{B} ; γ = \frac{{w}_{u , i}^{B}}{{w}_{u , u ′}^{S} + {w}_{u , i}^{B}} . \qquad ( 9 )$$

w_{u,u′}^{s} or w_{u,i}^{B} is referred to as at least one to-be-updated edge weight, w_{u,u′}^{s}+W_{u,i}^{B} is referred to as a first weight superimposition sum, w_{u,u′}^{s}, +w_{u,i} ^{B} is referred to as a second weight superimposition sum, β is referred to as a second enhancement parameter, and γ is referred to as a first enhancement parameter.

FIG. 11 is a schematic diagram of exemplary weight updating aggregation according to an embodiment of this disclosure. As shown in FIG. 11, during updating of a weight 11-1 (W_{A-C}) by using the attention mechanism, the updating is implemented based on the vertex A and the vertex D. During updating of the weight 11-1 by using the adaptive weighting mechanism, the updating is implemented based on a weight 11-1, a weight 11-2, and a weight 11-3 that are updated by using the attention mechanism.

Iterative processing is performed based on the formula (1) to the formula (9) to update the heterogeneous graph, thereby obtaining a final heterogeneous graph (which is referred to as a specified heterogeneous graph). The final heterogeneous graph includes a final account vector representation and a final advertisement vector representation. In this way, during advertisement recommendation in the advertisement recommendation phases 5-3, an advertisement CVR can be determined based on the vertex corresponding to the account u and the vertex corresponding to the advertisement i in the final heterogeneous graph, as shown by a formula (10).

$${Y}_{u , i} = Sigmoid ( {V}_{u} * {V}_{i} ) . \qquad ( 10 )$$

Vᵤ represents the vertex in the final heterogeneous graph corresponding to the account u, Vᵢ represents the vertex in the final heterogeneous graph corresponding to the advertisement i, SigmoidO is an activation layer function, and Vᵤ*Vᵢ is referred to as a result of fusing the recommendation object feature and the to-be-recommended information feature.

Herein, advertisement CVRs respectively corresponding to all advertisements (for example, N advertisements, N being a positive integer) are pre-estimated through the final heterogeneous graph, and the advertisements are sorted based on the advertisement CVRs to select an advertisement with a largest advertisement CVR and recommend the advertisement to the account, thereby achieving information recommendation.

Indicator data corresponding to the date processing method provided in the embodiments of this disclosure and baseline models for advertisement CVR estimation on a training data set, a validation data set, and a test data set is described below, as shown in Table 1.

TABLE 1

| | | Training data set | | Validation data set | | Test data set | |
|---|---|---|---|---|---|---|---|
| Date | Model | Loss | AUC | Loss | AUC | Loss | AUC |
| Day 1 | Baseline model | 0.6113 | 0.7079 | 0.6231 | 0.7036 | 0.6841 | 0.6108 |
| | Data processing method | 0.5401 | 0.8046 | 0.7545 | 0.6589 | 0.8087 | 0.6658 |
| Day 2 | Baseline model | 0.6335 | 0.6994 | 0.6111 | 0.7378 | 0.6366 | 0.7024 |
| | Data processing method | 0.5727 | 0.7728 | 0.6062 | 0.7488 | 0.6181 | 0.7255 |
| Day 3 | Baseline model | 0.6316 | 0.6910 | 0.6254 | 0.7153 | 0.6365 | 0.6959 |
| | Data processing method | 0.6153 | 0.7185 | 0.6364 | 0.6928 | 0.6171 | 0.7201 |
| Day 4 | Baseline model | 0.5810 | 0.7688 | 0.7970 | 0.7101 | 0.9122 | 0.6236 |
| | Data processing method | 0.6182 | 0.7191 | 0.6278 | 0.7098 | 0.6191 | 0.7203 |
| Day 5 | Baseline model | 0.6090 | 0.7151 | 0.6272 | 0.7097 | 0.6749 | 0.7044 |
| | Data processing method | 0.5392 | 0.7909 | 0.6145 | 0.7307 | 0.5866 | 0.7536 |
| Day 7 | Baseline model | 0.6133 | 0.7095 | 0.6455 | 0.6990 | 0.6234 | 0.7174 |
| | Data processing method | 0.4924 | 0.8281 | 0.6178 | 0.7334 | 0.6472 | 0.7231 |

It may be learned from Table 1 that the data processing method provided in the embodiments of this disclosure is superior to the baseline model.

Comparison results between the data processing method provided in the embodiments of this disclosure and a plurality of baseline models during application are described below.

FIG. 12 is a schematic diagram of exemplary model performance comparison according to an embodiment of this disclosure. As shown in FIG. 12, a horizontal axis represents an application date (May 7 to May 11), a vertical axis represents performance indicators (0.06 to 0.13), a curve 12-1 is performance information corresponding to a baseline model 1, a curve 12-2 is performance information corresponding to a baseline model 2, a curve 12-3 is performance information corresponding to a baseline model 3, and a curve 12-4 is performance information corresponding to the data processing method provided in the embodiments of this disclosure. It may be learned from the curve 12-1 to the curve 12-4 that the data processing method provided in the embodiments of this disclosure is superior to the baseline models 1 to 3 in terms of performance indicator.

It may be understood that, by fusing the social graph and click-through bipartite graph into the heterogeneous graph and performing nonlinear aggregation on the vertices in the heterogeneous graph corresponding to the accounts in combination with the edge weight, information exchange is implemented between the accounts and the advertisements, and an effective association with the advertisements is still established even in case of a cold start account. In addition, during the nonlinear aggregation, the edge weight is updated by using the adaptive attention mechanism during continuous updating of the vertices corresponding to the accounts, which can improve an effect of the nonlinear aggregation. In conclusion, the heterogeneous graph aggregation method provided in this embodiment of this disclosure can improve the accuracy of information recommendation for the cold start account and reduce the resource consumption of information recommendation.

An exemplary structure of the data processing apparatus 455 provided in the embodiments of this disclosure implemented as a software module is further described below. In some embodiments, as shown in FIG. 2, software modules in the data processing apparatus 455 stored in the memory 450 may include:
a feature obtaining module 4551, configured to obtain a recommendation object feature corresponding to a recommendation object, the recommendation object feature being obtained through a nonlinear mapping result of target second-order information, the target second-order information being obtained by aggregating an object feature corresponding to at least one interactive object and a first information feature corresponding to at least one piece of recommended information, the interactive object being an object configured to interact with the recommendation object, and the at least one piece of recommended information being full information converted by each interactive object,
the feature obtaining module 4551 being further configured to obtain a to-be-recommended information feature corresponding to to-be-recommended information, the to-be-recommended information being any recommended information converted by the interactive object; and
an information recommendation module 4552, configured to perform information recommendation for the recommendation object based on a result of fusing the recommendation object feature and the to-be-recommended information feature.

In this embodiment of this disclosure, the feature obtaining module 4551 is further configured to: obtain the target second-order information corresponding to the recommendation object; obtain a spatial distance between the target second-order information and specified center information, the specified center information being determined through a plurality of pieces of second-order information, the plurality of pieces of second-order information including the target second-order information; perform nonlinear mapping on the spatial distance based on a plurality of specified mapping parameters, to obtain a plurality of to-be-fused second-order features, the specified mapping parameters each representing a mapping space range; and obtain a first nonlinear mapping result corresponding to the plurality of to-be-fused second-order features, and obtain the recommendation object feature based on the first nonlinear mapping result, the nonlinear mapping result corresponding to the target second-order information including the first nonlinear mapping result.

In this embodiment of this disclosure, the feature obtaining module 4551 is further configured to: obtain an interaction weight between the recommendation object and the interactive object, the interaction weight representing intimacy between the recommendation object and the interactive object; obtain a conversion weight between the interactive object and the recommended information, the conversion weight representing a conversion degree between the interactive object and the recommended information; obtain a first fusion result of the interaction weight and the object feature and a second fusion result of the conversion weight and the first information feature, to obtain at least one first fusion result corresponding to the at least one interactive object and at least one second fusion result corresponding to the at least one piece of recommended information; and combine the at least one first fusion result and the at least one second fusion result corresponding to each interactive object, to form the target second-order information corresponding to the recommendation object.

In this embodiment of this disclosure, the data processing apparatus 455 further includes an object determining module 4553 configured to: obtain a conversion identifier of the recommendation object for a to-be-recommended information library, the to-be-recommended information library including the at least one piece of recommended information converted by each interactive object.

In this embodiment of this disclosure, the feature obtaining module 4551 is further configured to: aggregate, in a case that the conversion identifier indicates that the to-be-recommended information library includes at least one piece of converted information, at least one second information feature corresponding to the at least one piece of converted information, to obtain target first-order information corresponding to the recommendation object, the converted information being recommended information that has been converted by the recommendation object, and the second information feature being a feature of the converted information; and obtain a second nonlinear mapping result corresponding to the target first-order information, and combine the second nonlinear mapping result and the first nonlinear mapping result to form the recommendation object feature.

In this embodiment of this disclosure, the feature obtaining module 4551 is further configured to: combine the second nonlinear mapping result and the first nonlinear mapping result to obtain initial aggregation information; obtain a first combination weight negatively correlated with the initial aggregation information and positively correlated with the second nonlinear mapping result, and obtain a second combination weight corresponding to the first combination weight; fuse the first combination weight and the second nonlinear mapping result to obtain a third fusion result, and fuse the second combination weight and the first nonlinear mapping result to obtain a fourth fusion result; and combine the third fusion result and the fourth fusion result to obtain the recommendation object feature.

In this embodiment of this disclosure, the feature obtaining module 4551 is further configured to: determine the first nonlinear mapping result as the recommendation object feature in a case that the conversion identifier indicates that a conversion object library is independent of the recommendation object, the conversion object library being a set of objects configured to convert the recommended information in the to-be-recommended information library.

In this embodiment of this disclosure, the recommendation object feature and the to-be-recommended information feature are obtained through a specified heterogeneous graph, and the data processing apparatus 455 further includes a model training module 4554 configured to: construct an object interaction graph based on an interaction record between at least two first objects, the at least two first objects including the recommendation object and the at least one interactive object; construct an object information conversion graph based on a conversion record of at least one second object for at least one piece of initial recommended information, the at least one piece of initial recommended information including the at least one piece of recommended information converted by each interactive object; fuse the object interaction graph and the object information conversion graph based on a common object between the at least two first objects and the at least one second object, to obtain a to-be-updated heterogeneous graph; iteratively update, based on a nonlinear mapping result corresponding to second-order information of each object vertex in the to-be-updated heterogeneous graph, the object vertex in the to-be-updated heterogeneous graph; and determine the to-be-updated heterogeneous graph after the iterative updating as the specified heterogeneous graph.

In this embodiment of this disclosure, the model training module 4554 is further configured to perform the following processing on each object vertex in the to-be-updated heterogeneous graph: updating the object vertex based on the nonlinear mapping result corresponding to the second-order information of the object vertex; determining the updated to-be-updated heterogeneous graph as a current heterogeneous graph; performing attention updating on an edge weight in the current heterogeneous graph to obtain a to-be-updated edge weight; adaptively enhancing the to-be-updated edge weight to obtain a target edge weight; obtaining second-order information of each current object vertex in the current heterogeneous graph through aggregation based on the target edge weight; and iteratively updating the object vertex in the current heterogeneous graph based on a nonlinear mapping result corresponding to the second-order information of the current object vertex.

In this embodiment of this disclosure, the model training module 4554 is further configured to perform the following processing on each current object vertex in the current heterogeneous graph: obtaining at least one adjacent object vertex corresponding to the current object vertex; determining an attention interaction weight between the current object vertex and each adjacent object vertex based on the at least one adjacent object vertex; obtaining at least one adjacent information vertex corresponding to the current object vertex; and determining an attention conversion weight between the current object vertex and each adjacent information vertex based on the at least one adjacent information vertex, the to-be-updated edge weight being the attention interaction weight or the attention conversion weight.

In this embodiment of this disclosure, the model training module 4554 is further configured to: obtain at least one to-be-updated edge weight, the at least one to-be-updated edge weight being adjacent to a target to-be-updated edge weight and having a type different from that of the target to-be-updated edge weight, and the target to-be-updated edge weight being any to-be-updated edge weight to be adaptively enhanced; and enhance the target to-be-updated edge weight based on the at least one to-be-updated edge weight, to obtain the target edge weight.

In this embodiment of this disclosure, the information recommendation module 4552 is further configured to: determine, based on the result of fusing the recommendation object feature and to-be-recommended information feature, a CVR that the recommendation object converts the to-be-recommended information; sort, in a case that the to-be-recommended information library includes at least two pieces of to-be-recommended information, the at least two pieces of to-be-recommended information in a reverse order based on at least two CVRs of the recommendation object for the at least two pieces of to-be-recommended information, to obtain a to-be-recommended information sequence; and determine a specified quantity of to-be-recommended information successively selected from the to-be-recommended information sequence as target to-be-recommended information.

An embodiment of this disclosure provides a computer program product, including a computer program or computer-executable instructions stored in a computer-readable storage medium. A processor of a computer device (which is referred to as a data processing device) reads the computer program or the computer-executable instructions from the computer-readable storage medium, and the processor executes the computer program or the computer-executable instructions, so that the computer device performs the foregoing data processing method in the embodiments of this disclosure.

An embodiment of this disclosure provides a computer-readable storage medium having a computer program or computer-executable instructions stored therein. The computer program or the computer-executable instructions, when executed by a processor, cause the processor to perform the data processing method provided in the embodiments of this disclosure, for example, the data processing method shown in FIG. 3a.

In some embodiments, the computer-readable storage medium may be a memory such as a FRAM, a ROM, a PROM, an EPROM, an EEPROM, a flash memory, a magnetic surface memory, a compact disc, or a CD-ROM, or may be various devices including one of or any combination of the memories.

In some embodiments, the computer program or the computer-executable instructions may adopt any form such as a program, a software, a software module, a script, or code, may be written in a programming language of any form (including a compiled or interpreted language, or a declarative or procedural language), and may be deployed in any form, for example, deployed as a standalone program or as a module, a component, a subroutine, or another unit suitable for use in a computing environment.

In an example, the computer program or the computer-executable instructions may but may not necessarily correspond to files in a file system, may be stored in a part of the file for storing other programs or data, for example, stored in one or more scripts in a hyper text markup language (HTML), stored in a single file specially used for the discussed program, or stored in a plurality of collaborative files (for example, files for storing one or more modules, a subprogram, or a code part).

In an example, the executable instructions may be deployed on one computer device for execution (in this case, the computer device is the data processing device), or may be deployed on a plurality of computer devices at one location for execution (in this case, the plurality of computer devices at one location are the data processing device), or may be deployed on a plurality of computer devices distributed at a plurality of locations and connected through a communication network (in this case, the plurality of computer devices distributed at the plurality of locations and connected through the communication network are the data processing device).

It may be understood that, in the embodiments of this disclosure, related data such as the interaction record and the conversion record are involved. User permission or consent needs to be obtained when the embodiments of this disclosure are applied to specific products or technologies, and the collection, use, and processing of the related data need to comply with relevant laws, regulations, and standards of relevant countries and regions.

In conclusion, in the embodiments of this disclosure, during the obtaining of the target second-order information corresponding to the recommendation object and the determining of the recommendation object feature based on the nonlinear mapping result of the target second-order information, the target second-order information includes not only the interaction between the objects, but also the interaction between the objects and the recommended information, which is heterogeneous information. Therefore, by performing nonlinear mapping on the target second-order information to obtain the recommendation object feature corresponding to the recommendation object, an accurate association is established between the recommendation object and the recommended information. In this way, it can be accurately determined whether to recommend any recommended information to the recommendation object, thereby improving accuracy of a CVR. In addition, even in case of a cold start object, the accuracy of information recommendation can still be improved, and the resource consumption of information recommendation can still be reduced.

The foregoing disclosure includes some exemplary embodiments of this disclosure which are not intended to limit the scope of this disclosure. Other embodiments shall also fall within the scope of this disclosure.

What is claimed is:

1. A data processing method, comprising:
determining target second-order information based on current user feature information of at least one current user and first feature information of recommended information previously recommended to the at least one current user;
determining a nonlinear mapping of the target second-order information;
determining, by processing circuitry, new user feature information of a new user based on the nonlinear mapping of the target second-order information;
determining to-be-recommended feature information corresponding to recommended information of the previously recommended information to be recommended to the new user; and
generating a recommendation for the new user based on the new user feature information and the to-be-recommended feature information.

2. The method according to claim 1, wherein the previously recommended information includes advertisements converted by the at least one current user.

3. The method according to claim 1, further comprising:
determining center information of second-order information, the second-order information including the target second-order information;
determining a spatial distance between the target second-order information and the center information; and
determining to-be-combined second-order feature information based on the nonlinear mapping, the nonlinear mapping being based on the spatial distance and a plurality of mapping parameters, each of the plurality of mapping parameters representing a mapping space range, wherein
the nonlinear mapping of the target second-order information includes a first nonlinear mapping of a plurality of to-be-combined second-order features in the to-be-combined second-order feature information.

4. The method according to claim 3, further comprising:
determining an interaction weight between the new user and a current user of the at least one current user, the interaction weight representing an interaction degree between the new user and the current user;
determining a conversion weight between the current user and the previously recommended information, the conversion weight representing a conversion degree between the current user and the previously recommended information;
determining a first combination of the current user feature and the new user feature based on the interaction weight; and
determining a second combination of the first feature information based on the conversion weight; and
determining target second-order information corresponding to the new user based on the first combination and the second combination.

5. The method according to claim 3, further comprising:
determining a conversion identifier of the new user for a to-be-recommended information library, the to-be-recommended information library including the previously recommended information converted by the at least one current user; and
determining target first-order information of the new user when the conversion identifier indicates that the to-be-recommended information library includes the converted information, based on a second feature information corresponding to the converted information, the converted information being recommended information converted by the new user, and the second feature being of the converted information; and
determining a second nonlinear mapping of the target first-order information,
wherein the determining the new user feature information includes combining the second nonlinear mapping and the first nonlinear mapping.

6. The method according to claim 5, further comprising:
determining initial aggregation information based on the second nonlinear mapping and the first nonlinear mapping;
determining a first combination weight negatively correlated with the initial aggregation information and positively correlated with the second nonlinear mapping;
determining a second combination weight based on the first combination weight;
determining a third combination result based on the first combination weight and the second nonlinear mapping;
determining a fourth combination result based on the second combination weight and the first nonlinear mapping; and
determining the new user feature based on the third combination result and the fourth combination result.

7. The method according to claim 5, further comprising:
determining the first nonlinear mapping as the new user feature information.

8. The method according to claim 1, further comprising:
constructing a user interaction graph based on an interaction record between at least two first users, the at least two first users including the new user and the at least one current user;
constructing a user information conversion graph based on a conversion record of at least one second user for initial recommended information, the initial recommended information including the recommended information converted by the at least one current user;
generating a to-be-updated heterogenous graph based on the user interaction graph and the user information conversion graph according to a common user between the at least two first users and the at least one second user;
iteratively updating each user vertex in the to-be-updated heterogeneous graph based on a nonlinear mapping corresponding to second-order information of the respective user vertex in the to-be-updated heterogeneous graph; and
determining the new user feature and the to-be-recommended information feature based on the to-be-updated heterogeneous graph.

9. The method according to claim 8, further comprising:
updating the each user vertex in the to-be-updated heterogeneous graph based on the nonlinear mapping of the second-order information of the respective user vertex;
performing attention updating on an edge weight in the updated to-be-updated heterogeneous graph to determine a to-be-updated edge weight;
obtaining a target edge weight based on the to-be-updated edge weight;
determining second-order information of each current user vertex in the current heterogeneous graph through aggregation based on the target edge weight; and
iteratively updating the each current user vertex in the current heterogeneous graph based on a nonlinear mapping corresponding to the second-order information of the respective current user vertex.

10. The method according to claim 9, further comprising:
determining at least one adjacent user vertex corresponding to the each current user vertex;
determining an attention interaction weight between the each current user vertex and the at least one adjacent user vertex of the respective current user vertex;
determining at least one adjacent information vertex corresponding to the each current user vertex; and
determining, for each current user vertex, an attention conversion weight between the respective current user vertex and each of the at least one adjacent information vertex corresponding to the respective current user vertex based on the at least one adjacent information vertex, the to-be-updated edge weight being the attention interaction weight or the attention conversion weight.

11. The method according to claim 9, further comprising:
determining at least one to-be-updated edge weight, the at least one to-be-updated edge weight is adjacent to a target to-be-updated edge weight and different from the target to-be-updated edge weight; and
determining the target edge weight based on the target to-be-updated edge weight and the at least one to-be-updated edge weight.

12. The method according to claim 1, further comprising:
determining, based on the new user feature information and the to-be-recommended feature information, a conversion rate (CVR) that indicates a rate at which the new user converts the to-be-recommended information; and
selecting target to-be-recommended information from the to-be-recommended information based on the CVR,
wherein the recommendation includes the target to-be-recommended information.

13. A data processing apparatus, comprising:
processing circuitry configured to:
determine target second-order information based on current user feature information of at least one current user and first feature information of recommended information previously recommended to the at least one current user;
determine a nonlinear mapping of the target second-order information;
determine new user feature information of a new user based on the nonlinear mapping of the target second-order information;
determine to-be-recommended feature information corresponding to recommended information of the previously recommended information to be recommended to the new user; and
generate a recommendation for the new user based on the new user feature information and the to-be-recommended feature information.

14. The data processing apparatus according to claim 13, wherein the previously recommended information includes advertisements converted by the at least one current user.

15. The data processing apparatus according to claim 13, wherein
the processing circuitry is configured to:
determine center information of second-order information, the second-order information including the target second-order information,
determine a spatial distance between the target second-order information and the center information, and
determine to-be-combined second-order feature information based on the nonlinear mapping, the nonlinear mapping being based on the spatial distance and a plurality of mapping parameters, each of the plurality of mapping parameters representing a mapping space range; and
the nonlinear mapping of the target second-order information includes a first nonlinear mapping of a plurality of to-be-combined second-order features in the to-be-combined second-order feature information.

16. The data processing apparatus according to claim 15, wherein the processing circuitry is configured to:
determine an interaction weight between the new user and a current user of the at least one current user, the interaction weight representing an interaction degree between the new user and the current user;
determine a conversion weight between the current user and the previously recommended information, the conversion weight representing a conversion degree between the current user and the previously recommended information;
determine a first combination of the current user feature and the new user feature based on the interaction weight; and
determine a second combination of the first feature information based on the conversion weight; and
determine target second-order information corresponding to the new user based on the first combination and the second combination.

17. The data processing apparatus according to claim 15, wherein
the processing circuitry is configured to:
determine a conversion identifier of the new user for a to-be-recommended information library, the to-be-recommended information library including the previously recommended information converted by the at least one current user, and
determine target first-order information of the new user when the conversion identifier indicates that the to-be-recommended information library includes the converted information, based on a second feature information corresponding to the converted information, the converted information being recommended information converted by the new user, and the second feature being of the converted information, and
determine a second nonlinear mapping of the target first-order information; and
the determining the new user feature information includes combining the second nonlinear mapping and the first nonlinear mapping.

18. The data processing apparatus according to claim 17, wherein the processing circuitry is configured to:
determine initial aggregation information based on the second nonlinear mapping and the first nonlinear mapping;
determine a first combination weight negatively correlated with the initial aggregation information and positively correlated with the second nonlinear mapping;
determine a second combination weight based on the first combination weight;
determine a third combination result based on the first combination weight and the second nonlinear mapping;
determine a fourth combination result based on the second combination weight and the first nonlinear mapping; and
determine the new user feature based on the third combination result and the fourth combination result.

19. The data processing apparatus according to claim 17, wherein the processing circuitry is configured to:
determine the first nonlinear mapping as the new user feature information.

20. A non-transitory computer-readable storage medium storing instructions which, when executed by a processor, cause the processor to perform:
determining target second-order information based on current user feature information of at least one current user and first feature information of recommended information previously recommended to the at least one current user;
determining a nonlinear mapping of the target second-order information;
determining new user feature information of a new user based on the nonlinear mapping of the target second-order information;
determining to-be-recommended feature information corresponding to recommended information of the previously recommended information to be recommended to the new user; and
generating a recommendation for the new user based on the new user feature information and the to-be-recommended feature information.
